(19) United States
(12) Patent Application Publication
(10) Pub. No.: US 2007/0088135 A1
(43) Pub. Date: Apr. 19, 2007

(54) Blends with shape memory characteristics

(75) Inventors: Andreas Lendlein, Berlin (DE); Ute Ridder, Aachen (DE)

Correspondence Address: PATREA L. PABST;PABST PATENT GROUP LLP, 400 COLONY SQUARE, SUITE 1200, ATLANTA, GA, 30361, US

(73) Assignee: ANDREAS LEDNLEIN AND UTE RIDDER

(21) Appl. No.: 10/552,654

(22) PCT Filed: Mar. 23, 2004
(86) PCT No.: PCT/EP04/03066

§ 371 Date: Mar. 28, 2006

(30) Foreign Application Priority Data
Apr. 10, 2003 (DE) 10316573.8

(51) Int. Cl. C08L 67/00; C08G 63/02; C08G 63/08

(52) U.S. Cl. 525/444; 525/272; 525/354

(57) ABSTRACT

The invention relates to a polymer blend with shape-memory characteristic comprising two different block copolymers each containing at least one hard segment and at least one soft segment, whereby the two different block copolymers comprise the same soft segment and only differ with regard to the hard segment.

The invention relates to blends with shape-memory characteristics, which are preferably biologically degradable, block copolymers, suitable for the production of such blends, methods for the production of block copolymers as well as for the production of the blends and uses of the products mentioned above.

### STATE OF THE ART

The demand for tailor-made high performance polymers with a wide profile of characteristics continues to increase. Consequently, new ways are always being sought of producing these polymers as economically as possible. One way of obtaining polymers with tailor-made characteristics lies in the synthesis of new monomers and their polymerisation to homo- or copolymers and in the development of new polymerisation methods. These sorts of developments are however linked to high cost and time expenditure so that they are only profitable when the required characteristics cannot be achieved by other methods and a high turnover of the newly developed polymers is expected.

Due to the increased quantities of plastics used in the growth sectors, it appears to be economically practicable to fulfill the new requirements on polymers by a combination of existing polymers or to develop new, comparatively simple polymers which satisfy a required profile of requirements in combination with other polymers.

However, it is important in the production of polymer blends that, in particular for achieving a standardized and reproducible profile of characteristics, thorough and simple mixing of the various polymers in the blend must be ensured.

An important class of innovative polymer systems, which have received very much attention recently, are the so-called shape-memory polymers (also known as SMP polymers or SMP materials in the following), whereby materials are involved which can change their external shape due to an external stimulus. Normally here, a shape-memory effect is facilitated by a combination of polymer morphology with the processing and programming methods. In doing this, normally the material is brought into the permanent shape using conventional processing methods by melting above the highest thermal transition point T_{PERM}. The basic material can be deformed by heating above the acoustic temperature T_{TRANS} and fixed in this state by cooling to a temperature below T_{TRANS}. A temporary shape is thus obtained. This procedure is known as programming (see FIG. 1). The permanent form can be restored by an external stimulus, normally a temperature change. If a temperature change is used as the stimulus, this is known as a thermally induced shape-memory effect (FIG. 2).

Shape-memory polymers must have two separate phases with different temperature transitions. Here, the phase with the highest temperature transition, T_{PERM}, determines the permanent shape and the phase with the lowest temperature transition determines the so-called switching temperature of the shape-memory effect, T_{TRANS}. Specific development of shape-memory polymers has started in recent years. There are increasing reports about linear, phase-segregated multiblock copolymers, usually polyurethane systems, under the generic term of shape-memory polymer. These materials, which are-normally elastic, have a phase with a high transition temperature, T_{PERM}, (hard segment formation phase), which acts as a physical cross-linker and determines the permanent shape. The physical cross-linkage normally occurs by crystallisation of individual polymer segments or by solidification of amorphous areas. This physical cross-linkage is thermally reversible and above T_{PERM} such materials can be processed thermoplastically. Thermoplastic elastomers are involved. A second phase, which has a lower transition temperature, acts as the switching segment. This transition can be both a glass transition temperature (Tg) or also a melting transition (Tm). In the case of block copolymers both segments forming different phases are chemically covalently linked with one another.

From WO 99/42147 various shape-memory polymers are known. This published patent application describes also blends of two thermoplastic SMP materials. A similar disclosure is also present in WO 99/42528.

JP-A-11-209595 describes a polymer composition, which is biologically degradable and can be formed by melting and which exhibits shape-memory characteristics. This polymer composition comprises a polymer blend, principally containing polylactide and polyepsilon caprolactone.

JP-A-2-123129 discloses a thermoplastic composition, which can be formed in the molten state and which exhibits shape-memory characteristics. This composition comprises an aromatic polyester and an aliphatic polylactone.

EP-A-1000958 discloses a biologically degradable shape-memory material based on a lactide polymer.

From WO 01/07499, shape-memory polyurethanes are known which can also be used in the form of blends.

JP-A-04-342762 discloses shape-memory compositions with improved characteristics with regard to colouring and handling, whereby these compositions comprise at least one shape-memory polymer.

In Thermochimica Acta 243(2), 253 (1994) two shape-memory polymers based on solutions were investigated. Here, polymer blends were also investigated.

The disadvantage of the known shape-memory materials mentioned above is however that with polymer blends the shape-memory effect can only be ensured by the use of a polymer with shape-memory characteristics. Special polymers of this nature require however a large amount of effort in their manufacture and it is not ensured that an actual shape-memory effect occurs for a polymer system with all conceivable mixing ratios.

### OBJECT OF THE INVENTION

Taking the disadvantages described above, the object of the invention is to provide a blend with shape-memory characteristics, whereby preferably the polymers on which the blend is based do not themselves need to be shape-memory materials. Furthermore, the blend should preferably be biologically degradable.

### BRIEF DESCRIPTION OF THE INVENTION

The above mentioned object is solved by the polymer blend according to claim 1. Preferred embodiments are given in the subclaims. Furthermore, the invention makes block copolymers available, which are suitable for the production of blends according to the invention, as well as methods for the production of the blend and the block copolymers and uses of the block copolymers and the blends. Preferred embodiments of these aspects of the invention are given in the respective subclaims.

### BRIEF DESCRIPTION OF THE FIGURES

FIG. 1 schematically illustrates the shape-memory effect.

FIG. 2 schematically shows a temperature induced shape-memory effect.

FIG. 3 schematically shows a polymer blend according to the invention.

### DETAILED DESCRIPTION OF THE INVENTION

The invention makes a blend available of two different block copolymers, whereby the blend exhibits shape-memory characteristics. The two block copolymers each comprise at least one hard segment and at least one soft segment. Both segments are preferably selected from the group of segments linked by ester bindings, whereby also esterether segments are preferred according to the invention. Preferably the respective segments are selected from non-aromatic segments and, particularly preferably, the block copolymers to be used according to the invention themselves exhibit no shape-memory characteristics, but rather only the blend.

The block copolymers used in the blend according to the invention are preferably selected such that the respective soft segments are identical, so that the block copolymers differ only with regard to the hard segments. In this way good mixing properties and satisfactory shape-memory characteristics can be ensured.

An alternative way of ensuring good mixing properties (compatibility) of the two block copolymers is when, also with the presence of different soft segments, the groups in the block copolymers, which link the various blocks, are selected such that good mixing properties are obtained. This is in particular possible with block copolymers which are linked by urethane segments. The urethane segments ensure the mixing capability so that the soft segments of the at least two block copolymers present in the blend can also be different from one another, which facilitates additional influence on the mechanical characteristics.

According to the invention, the hard segments are selected from segments which are crystalline or partially crystalline, whereas the soft segments are selected from amorphous segments.

Principally, both the hard segment and also the soft segment can be present in the form of homopolymer segments or in the form of copolymer segments. However, preferably the soft segments are selected from copolymer segments.

Principally, the two block copolymers essential for the invention are present in any required mixing ratios, but it has been shown that satisfactory shape-memory characteristics are obtained when the two block copolymers are present in the blend in a proportion from 10:1 to 1:10.

The block copolymers to be used in the blend according to the invention are particularly preferably selected from block copolymers, the hard segments of which are selected from poly-p-dioxanone and polyepsilon caprolactone and the soft segments of which are selected from copolyepsilon caprolactone glycolide and a polyester or polyetherester segment of an aliphatic dicarboxylic acid and an aliphatic diol, preferably polyalkylene adipinate.

The individual segments are preferably present in the block copolymers so that they are linked to one another by urethane bindings. Block copolymers of this nature can for example be produced from appropriate diol-functionalised macromonomers (i.e. precursor substances appropriate to the segments), if these macromonomers are present in the form of diols, so that a block polymer with urethane bindings can be obtained by the reaction with an isocyanate. Principally, here any normal isocyanate can be used, but the isocyanate trimethyl hexamethylene diisocyanate is preferred.

The gram-molecular weights of the respective block copolymers and their polydispersity figures are not critical provided long highly polymer compounds are present. Normal gram-molecular weights lie in the range of 7,500 to 250,000 (number average of the molecular weight), whereby molecular weights from 10,000 to 150,000 and in particular from 20,000 to 80,000 (number average of the molecular weight) are preferred. The individual segments within the block copolymers exhibit here preferably molecular weights in the range of 1,000 to 20,000 (number average of the segments) and in particular in the range of 2,000 to 10,000 (number average of the molecular weight).

The polydispersities of the block copolymers lie preferably in the range from 1.5 to 5 and particularly preferably in the range of 2 to 4, whereby these values have not proved to be particularly critical for the manufacture of blends with shape-memory characteristics.

Further details of gram-molecular weights of the segments and the block copolymers are given further below again with regard to specially preferred block copolymers. The values listed there, which in each case relate to single block copolymers, also apply correspondingly to the blends according to the invention.

The blends according to the invention in their preferred embodiment, i.e. in particular when non-aromatic ester segments and/or esterether segments are present, exhibit excellent biological compatibility and biological degradability, so that in particular use in the medical field is conceivable, for example in the form of implant material, in the sector of tissue engineering, as nerve tissue regeneration supporting material or as skin replacement material.

The blends according to the invention furthermore exhibit a transition temperature for the shape-memory effect which lies in the region of the body temperature, so that also for this reason the materials according to the invention are especially suitable for use in the medical field.

Apart from the block copolymers essential for the invention, the blends according to the invention can exhibit other constituents, which do not detrimentally affect the characteristics of the blends according to the invention and are practicable or necessary in the respective field of use. The additional constituents quoted here can also be used with the application of the block copolymers according to the invention depending on the requirements of the field of use. Additional constituent parts of this nature are, e.g. medically/pharmaceutically effective materials, additives for further modification of the physical characteristics or auxiliary materials, such as dyes or filling materials, etc.

In the following some preferred special block copolymers are described which are suitable for the production of the blend according to the invention.

As already explained above, the hard segments of the block copolymers according to the invention are preferably selected from poly-p-dioxanone and polyepsilon caprolactone. The soft segments are preferably selected from copolyepsilon caprolactone glycolide as well as a polyester or polyetherester segment from an aliphatic dicarboxylic acid and an aliphatic diol, preferably polyalkylene adipinate. The alkylene component in the polyalkylene adipinate is preferably selected from ethylene, butylene, and diethylene, so that this soft segment can be obtained by the reaction of adipic acid or a suitable derivative of it with the diols ethylene glycol, butylene glycol and diethylene glycol. The above mentioned diols can either be used singly or also in any required blend.

Hard Segment of Poly-p-dioxanone

The hard segment of poly-p-dioxanone, which can be used in the block copolymers according to the invention, exhibits preferably a gram-molecular weight of 1,500 to 5,000, especially preferably of 2,500 to 4,000. A particularly preferable embodiment of this hard segment exhibits the following schematic formula, whereby n and m are each selected such that the above mentioned gram-molecular weights (number averages) are obtained, whereby the respective proportion depends on the production method. 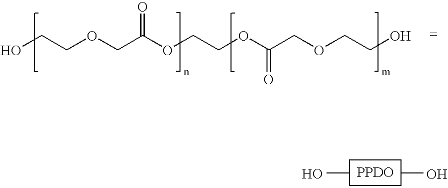
Hard Segment of Polyepsilon Caprolactone

Another preferred hard segment according to the invention is a polyepsilon caprolactone with a number average for the molecular weight from 1,000 to 20,000, preferably 1,200 to 12,000 and particularly preferably from 1,250 to 10,000. Depending on the molecular weight, this hard segment exhibits a melting temperature of 35° C. to 54° C. This hard segment can be schematically represented by the following formula, whereby n and m in turn represent the respective proportions needed to obtain the above mentioned molecular weights.

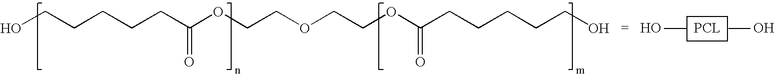

Both hard segments are preferably present, before the production of the block copolymer, in the form of diols, so that a polyurethane can be obtained by reaction with an isocyanate.

Soft Segment of Polyepsilon Caprolactone Glycolide

This amorphous, non-crystallisable soft segment preferably has a molecular weight from 1,000 to 5,000, particularly preferably from 2,000 to 3,000 (number average of the molecular weight). This soft segment can be represented schematically by the following formula, whereby in particular a polyepsilon caprolactone glycolide is preferred. Also this segment is preferably present before the production of the block copolymers in the form of a diol, so that production of a polyurethane is possible through the above mentioned reaction with an isocyanate. 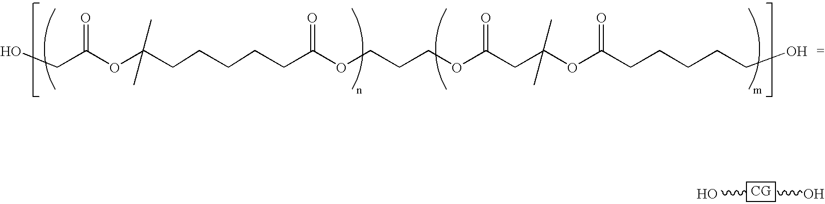
Soft Segment of Dicarboxylic Acid and Diol, Preferably Polyalkylene Adipinate

This soft segment comprises a condensation product of an aliphatic dicarboxylic acid and an aliphatic diol. The dicarboxylic component preferably comprises two to eight carbon atoms and, apart from the two carboxyl groups, it can also comprise other substituents, such as halogen atoms or hydroxyl groups or a double or triple binding in the chain, which could facilitate a later further modification of the block copolymers. Representative examples of dicarboxylic acids of this nature, which can be used singly or in combination, comprise adipic acid, glucaric acid, succinic acid, oxalic acid, malonic acid, pimelic acid, maleic acid, fumaric acid and acetylene dicarboxylic acid, whereby adipic acid is preferred. The diol component comprises preferably two to eight carbon atoms and is preferably selected from glycols with an even number of carbon atoms, especially preferably from ethylene glycol, butylene glycol and diethylene glycol. These diols are preferably present in a blend, whereby a blend of the three latter mentioned diols is especially preferred.

The especially preferred embodiment of this soft segment can be represented by the following formula and is a polyetherester of adipic acid and the above mentioned diols. Also this soft segment exhibits preferably terminal hydroxyl groups, so that a polyurethane formation is possible through a reaction with an isocyanate. This segment preferably has a molecular weight from 500 to 5,000, especially preferably from 1,000 to 2,000 (number average of the molecular weight). The glass transition temperature varies here from approx. −61° C. to −55° C. with increasing molar mass. Commercially an especially preferred soft segment is available under the designation Diorez® (termed PADOH in the following), which is a polyetherester diol of adipic acid, ethylene glycol, butylene glycol and diethylene glycol and can be represented by the following schematic formula.

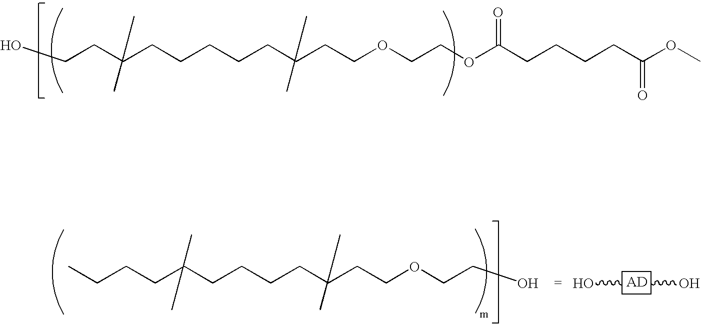

The above mentioned hard and soft segments can be linked to form block copolymers, whereby preferably an isocyanate, especially preferably trimethyl hexamethylene diisocyanate (isomer blend) is used. The reaction can take place in the usual way, whereby however an equimolar starting quantity must be ensured, in particular to obtain sufficiently high molecular weights.

Block Copolymers

The designation of the block copolymers in the following is based on the abbreviations given below:

| | |
|---|---|
| Hard segments | |
| Poly-p-dioxanone: | PPDO |
| Polyepsilon caprolactone: | PCL |
| Soft segments | |
| Polyepsilon caprolactone glycolide: | CG |
| Polyalkylene adipinate: | AD |

The block copolymers of PPD and CG are therefore designated in the following as PDCG, the block copolymers of PPDO and AD are designated in the following as PDA, the block copolymers of PCL and AD are designated in the following as PCA and the block copolymers of PCL and CG are designated in the following as PCCG. These block copolymers are especially suitable for the production of the polymer blends according to the invention, whereby in particular blends of PDA and PCA are preferred.

These four combinations of hard and soft segments represent the block copolymers according to the invention, whereby for these block copolymers the general statements given above for polydispersities and molecular weights apply. For the individual block copolymers more special preferred ranges can however be quoted.

PDCG: Polydispersities preferably from 1.5 to 5, more preferably from 1.7 to 4.5. Number averages of the molecular weights preferably from 8,000 to 60,000, more preferably from 10,000 to 50,000.

PCA: Polydispersities preferably from 1.5 to 8, more preferably from 1.7 to 4. Number averages of the molecular weights preferably from 20,000 to 150,000, more preferably from 25,000 to 110,000.

PDA: Polydispersity preferably from 2 to 4, more preferably from 2.5 to 3.6. Number averages of the molecular weights preferably from 10,000 to 50,000, more preferably from 20,000 to 35,000.

With the block copolymers according to the invention the proportion of hard segment in the block copolymer is preferably in the range from 25 to 75% wt., more preferably in the range from 25 to 60% wt. for PDCG, in the range from 35 to 70% wt. for PDA and preferably in the range from 30 to 75% wt. for PCA.

The block copolymers according to the invention are thermoplastic materials, which, although they themselves do not exhibit any shape-memory characteristics, when blended with one another they surprisingly exhibit shape-memory characteristics. Also, due to their material characteristics, the individual block copolymers are however already interesting and potentially valuable substances, in particular in the medical field.

The block copolymers according to the invention exhibit good tissue compatibility and are degradable in a physiological environment, whereby no toxic decomposition products arise. The thermoplastic processing capability furthermore facilitates spinning of the materials to threads, which can then be optionally knitted. On one hand filaments are obtained, which for example are interesting as seam materials, and on the other hand there are three-dimensional structures which are interesting as carriers in the field of tissue engineering.

The block copolymers according to the invention are however particularly suitable for the production of the blends according to the invention, which exhibit shape-memory characteristics. Here, the respective block copolymers are selected in conformance with the above mentioned criteria. The blends then exhibit a shape-memory effect, which can be explained as follows.

The blend according to the invention comprises two block copolymers, which differ with regard to the hard segments, but are identical with regard to the soft segments. The melting temperature of a hard segment forms the highest thermal transition and lies above the service temperature, whereas the glass transition of the amorphous soft segment lies below this temperature. Below this melting range of the first mentioned hard segment at least two phases are present. Crystalline domains of the hard segment affect the mechanical strength, whereas rubbery elastic regions of the amorphous soft segments determine the elasticity. Consequently, the blends according to the invention combine good elastic characteristics with good mechanical strength.

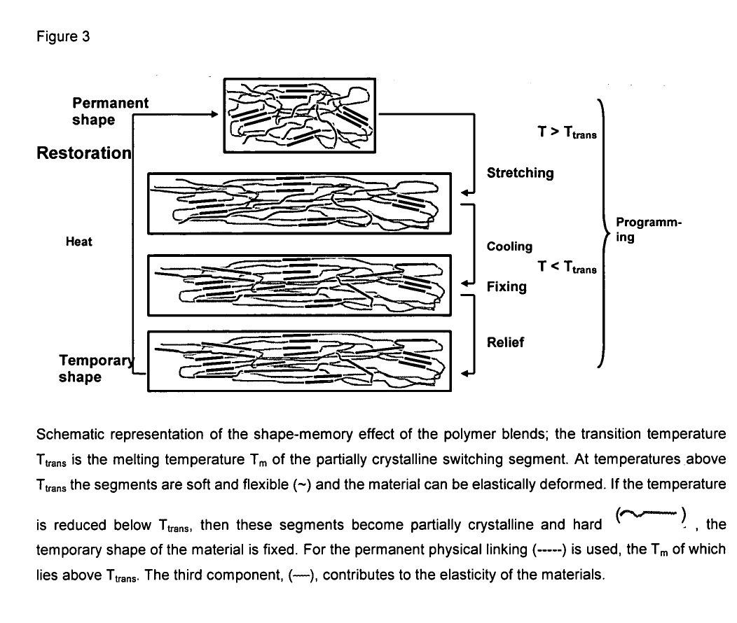

The permanent shape of the polymer blend of two block copolymers, which are designated as A and B in the following (FIG. 3), results from the thermally reversible linking of the phase forming the hard segment in the block copolymer A. The phase is characterised by a melting transition above the switching temperature. The fixing of the temporary shape occurs by the crystallisation of a switching segment, which forms the phase forming the hard segment in the block copolymer B. The melting transition of this segment determines T_{TRANS} for the shape-memory transition. The non-crystallisable soft segment of the block copolymers forms a third, rubbery elastic phase (soft phase) in the polymer blends and is formed from the same amorphous segment. This amorphous segment contributes both to the mixing capability of the block copolymers and also to the elasticity of the polymer blends. This concept is shown schematically in FIG. 3.

The segments forming the two phases, which determine the temporary and permanent shapes, are not covalently linked to one another, because they belong to two different block copolymers. Control of the shape-memory characteristics and of the mechanical characteristics can be achieved by varying the proportions of the multiblock copolymers used in the blend.

The production of the polymer blends according to the invention can occur in a manner known to the person skilled in the art. However, here mixing preferably takes place in the extruder (extrusion mixing) and in the dissolved state, whereby particularly good thoroughly mixed polymer blends can be obtained. With regard to the handling capability, extrusion mixing is however preferred, in particular because in this case also larger quantities of polymer can be processed without having to resort to potentially risky solvents.

The following examples explain the invention in more detail.

### EXAMPLES

A group of potentially biologically compatible, degradable materials are represented by polymers from the macrodiols PPDO and ran-CG. The homo-/copolymers, which are formed from the same monomers, are known to be biologically compatible and are already used for medical applications. The model of the phase-separated multiblock copolymers with a partially crystalline hard segment (PPDO), the melting temperature Tₘ of which is higher than the service temperature Tᵤₛₑ and an amorphous soft segment (ran-CG) with a low glass transition temperature T_{g}, serves as a structural concept. The crystallisable diol affects the strength and the non-crystallisable, amorphous diol determines the elasticity and the characteristics of the polymer at low temperatures.

Synthesis and Composition of the Multiblock Copolymers

For the synthesis of multiblock copolymers of the type PDCG from the macrodiols PPDO (Mₙ=2800 g·mol⁻¹) and ran-CG (Mₙ=2500 gmol⁻¹), the reaction with a diisocyanate as linking unit (Equ. 4.1) can be used.

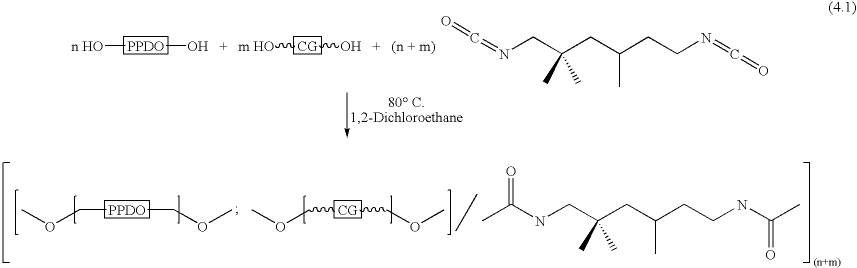

To achieve a higher reaction conversion attention must be paid to the use of equimolar proportions of the educts referred to the end groups. For the synthesis of the PDCG the aliphatic isomer blend of 2,2,4- and 2,4,4-trimethyl hexamethylene diisocyanate (TMDI) is selected as the linking unit, because on one hand the formation of crystalline urethane segments is prevented and on the other hand aliphatic amines as degradation products exhibit a lower toxicity than aromatic amines.

The reaction must be carried out with the elimination of moisture, because the isocyanate reacts with water to form amines which leads to the unwanted formation of urea derivatives. At higher temperatures urethane groups can react further with an isocyanate to form allophanate and with urea groups to form biuret. These secondary reactions change the composition of the reaction blend through the loss of equimolarity, leading to lower reaction conversions.

To examine the effect of the hard segment proportion in the product on the thermal and mechanical characteristics and the hydrolytic degrading rate, the concentrations of the macrodiols are varied in the synthesis of the polymers.

The composition of the produced polymers (Tab. 0.1) is determined using ¹H-NMR spectroscopy and the molar mass is found using GPC.

TABLE 0.1
Molar masses Mₙ and M_{w}, polydispersity PD, found using GPC
(cf. Chap.), and composition of the PDCG polymers, found
using ¹H-NMR spectroscopy.

| | Mₙ | M_{w} | | PPDO | ran - CG | TMDI |
|---|---|---|---|---|---|---|
| Polymer | g · mol⁻¹ | g · mol⁻¹ | PD | % wt. | % wt. | % wt. |
| PDCG(28) | 21000 | 48400 | 2.30 | 28 | 64 | 8 |
| PDCG(30) | 19700 | 89300 | 4.53 | 30 | 59 | 11 |
| PDCG(43) | 26800 | 74600 | 2.78 | 43 | 50 | 7 |
| PDCG(52) | 11300 | 42400 | 3.75 | 52 | 40 | 8 |
| PDCG(55) | 45900 | 78200 | 1.70 | 55 | 35 | 10 |

The determined proportion of hard segment varies between 28% wt. and 55% wt. and corresponds approximately to the proportion of the PPDO used in the respective reaction materials. Mean molar masses M_{w} of 42000 g·mol¹ to 89000 g·mol⁻¹ were achieved. The partially increased values for the polydispersity (up to 4.53) indicate secondary reactions which lead to branching of the polymer.

Another group of biologically compatible, degradable multiblock copolymers are represented by multiblock copolymers from PPDO and PADOH. The synthesis and composition of the polymers is followed by the presentation of the thermal and mechanical characteristics. Finally, the results of the hydrolytic degradation of this polymer system are presented.

Synthesis and Composition of the Polymers

For this polymer system PPDO is used with a molar mass Mₙ of 2800 g·mol⁻¹ as partially crystalline hard segment and a poly(alkylene glycol adipate)diol (PADOH, Diorez®, IV) is used as amorphous soft segment and TMDI is employed as a linking unit as an isomer blend. Poly(alkylene glycol adipate)diol consists of a combination of adipic acid and the diols ethylene glycol, butylene glycol and diethylene glycol and is described as being biologically compatible and degradable. The applied mean molar masses Mₙ of the

PADOH used are 1000 g·mol⁻¹ (PADOH1000) respectively 2000 g·mol⁻¹ (PADOH2000).

The synthesis of the PDA polymers occurs analogously to the synthesis of the PDCG polymers described above. With regard to commercial uses and an associated thermoplastic processing, it is important to be able to synthesize the polymers in large quantities. This could be realised with starting amounts up to 800 g.

The mean molar masses of the produced polymers determined using GPC and the composition of these polymers determined using ¹H-NMR spectroscopy and which contain PADOH with a molar mass Mₙ of 1000 g·mol⁻¹ (PADOH1000), are listed in Tab. 0.2.

TABLE 0.2
Molar masses Mₙ and M_{w}, polydispersity PD, found using GPC (cf.
Chap.), and composition, determined using ¹H-NMR spectroscopy, of
the PDA polymer starting materials for up to 800 g of product,
which contain PADOH1000 as amorphous soft segment.

| | Mₙ | M_{w} | | | | |
|---|---|---|---|---|---|---|
| | g · | g · | | PPDO | PADOH | TMDI |
| Polymer | mol⁻¹ | mol⁻¹ | PD | % wt. | % wt. | % wt. |
| PDA(42, 1) | 32500 | 96600 | 2.97 | 42 | 45 | 13 |
| PDA(50, 1) | 25000 | 66300 | 2.65 | 50 | 37 | 13 |
| PDA(64, 1) | 23900 | 80200 | 3.36 | 64 | 24 | 12 |

The values achieved for M_{w} lie between 66000 g·mol⁻¹ and 97000 g·mol⁻¹ with a polydispersity between 2.65 and 3.36. The weight proportion of the partially crystalline hard segment is 42% wt., 50% wt. and 64% wt. and the TMDI proportion is 13% wt. With the above starting ingredients the proportion of hard segment in the resulting polymer corresponds approximately to the charged proportion.

To examine the effect of the chain length of the soft segment on the thermal and mechanical characteristics of the polymers, two polymers with PADOH with a molar mass Mₙ of 2000 g·mol⁻¹ (PADOH2000) were synthesized. The molar masses and compositions obtained are shown in Tab. 0.3.

TABLE 0.3
Molar masses Mₙ and M_{w}, polydispersity PD, found using GPC, and
composition of the PDA polymers, found using ¹H-NMR spectroscopy,
with PADOH2000 as amorphous soft segment.

| | Mₙ | M_{w} | | | | |
|---|---|---|---|---|---|---|
| | g · | g · | | PPDO | PADOH | TMDI |
| Polymer | mol⁻¹ | mol⁻¹ | PD | % wt. | % wt. | % wt. |
| PDA(42, 2) | 25900 | 77100 | 2.98 | 42 | 49 | 9 |
| PDA(66, 2) | 23100 | 82200 | 3.56 | 66 | 25 | 9 |

The values obtained for M_{w} lie between 77100 g·mol⁻¹ and 82200 g·mol⁻¹, the polydispersity is between 2.98 and 3.56. The proportion of partially crystalline hard segment lies between 42% wt., respectively 66% wt. with a proportion of TMDI of 9% wt. The proportions of hard segment obtained in the polymer correspond within the range of the error limits to the charged ratios.

A further examined system are multiblock copolymers of caprolactone and alkylene glycol adipate. For this polymer system PCL with various molar masses Mₙ of 1250 g·mol⁻¹, 2000 g·mol⁻¹ and 10000 g·mol⁻¹ is used as the partially crystalline hard segment. PADOH is used as the amorphous soft segment and TMDI is used as the linking unit. The molar mass Mₙ of the soft segment is 1000 g·mol⁻¹ respectively 2000 g·mol⁻¹.

The synthesis of the PCA multiblock copolymers occurs analogously to the previously presented syntheses of the PDCG polymers and the PDA polymers. The molar masses are determined by means of GPC and achieve values for M_{w} from 48800 g·mol⁻¹ to 177600 g·mol⁻¹. The composition of the polymers is determined by means of ¹H-NMR spectroscopy (Tab. 0.4).

TABLE 0.4
Molar masses Mₙ, M_{w}, polydispersity PD found by means of GPC
(cf. Chap.) and composition of the PCA polymers, found by means
of ¹H-NMR spectroscopy, which contain PADOH1000 as amorphous soft
segment and PCL of various molar masses as hard segment.

| | M_{nPCL} | Mₙ | M_{w} | | PCL | PADOH | TMDI |
|---|---|---|---|---|---|---|---|
| Polymer | g · mol⁻¹ | g · mol⁻¹ | g · mol⁻¹ | PD | % wt. | % wt. | % wt. |
| PCA(51, 1250, 1) | 1250 | 27900 | 48800 | 1.75 | 51 | 33 | 16 |
| PCA(32, 2, 1) | 2000 | 30500 | 64900 | 2.13 | 32 | 52 | 16 |
| PCA(50, 2, 1) | 2000 | 36900 | 96600 | 2.62 | 50 | 34 | 16 |
| PCA(72, 2, 1) | 2000 | 47400 | 177600 | 6.75 | 72 | 14 | 14 |
| PCA(51, 10, 1) | 10000 | 54100 | 143900 | 2.66 | 51 | 38 | 11 |
| PCA(52, 10, 1) | 10000 | 45200 | 99400 | 2.13 | 52 | 36 | 12 |
| PCA(59, 10, 1) | 10000 | 46400 | 82100 | 1.77 | 59 | 31 | 10 |
| PCA(72, 10, 1) | 10000 | 31800 | 100700 | 3.17 | 72 | 20 | 8 |

The polydispersity of the materials lies between 1.75 and 6.75 and increases with increasing molar mass. The proportion of partially crystalline segment for the PCL200 used extends from 32% wt. to 72% wt., whereas for the PCL10000 used a proportion from 51% wt. to 72% wt. is present. For PCL1250, the lowest molar mass used for PCL, only one polymer with 51% wt. of partially crystalline segment is synthesized, because this material is very waxy and appears not to be suitable for further examinations. All materials are produced with starting ingredients up to 100 g. With regard to a commercial use and associated thermoplastic processing, two polymers with PCL2000 and PADOH1000 as standard diols are selected from this system and synthesized with starting ingredients up to 600 g. The composition and molar masses achieved for the resulting materials are described in Table 0.5. The values for M_{w} obtained in these macro charges are higher than for the micro charges and lie between 360000 g·mol⁻¹ to 375000 g·mol⁻¹.

TABLE 0.5
Molar masses Mₙ and M_{w}, polydispersity PD found by means of GPC
(cf. Chap.) and composition of the PCA polymer macro charges with
PADOH1000 as amorphous soft segment and PCL2000 as partially
crystalline hard segment found by means of ¹H-NMR spectroscopy.

| | Mₙ | M_{w} | | | | |
|---|---|---|---|---|---|---|
| | g · | g · | | PCL | PADOH | TMDI |
| Polymer | mol⁻¹ | mol⁻¹ | PD | % wt. | % wt. | % wt. |
| PCA(47, 2, 1) | 102900 | 375200 | 3.65 | 47 | 38 | 15 |
| PCA(68, 2, 1) | 96700 | 359100 | 3.71 | 68 | 20 | 12 |

The proportion by weight of partially crystalline segment is 47% wt., resp. 68% wt. with a PADOH1000 proportion of 38% wt., resp. 20% wt., which corresponds approximately to the charged ratio. For examining the effect of the molar mass of the soft segment materials with PADOH2000 as the soft segment and PCL2000 as the partially crystalline segment are produced in micro charges (Tab. 0.6).

TABLE 0.6
Molar masses Mₙ and M_{w}, polydispersity PD found by means of GPC
(cf. Chap.) and composition of the PCA polymers found by means of
¹H-NMR spectroscopy with PADOH2000 as amorphous soft segment and
PCL2000 as partially crystalline hard segment.

| | Mₙ | M_{w} | | | | |
|---|---|---|---|---|---|---|
| | g · | g · | | PCL | PADOH | TMDI |
| Polymer | mol⁻¹ | mol⁻¹ | PD | % wt. | % wt. | % wt. |
| PCA(48, 2, 2) | 88600 | 279200 | 3.15 | 48 | 42 | 10 |
| PCA(69, 2, 2) | 62700 | 164100 | 2.62 | 69 | 21 | 10 |

The molar masses M_{w} achieved lie between 164000 g·mol⁻¹ and 280000 g·mol ⁻with a polydispersity of 2.62 to 3.15. The weight proportion of PCL achieved lies between 48% wt., resp. 69% wt. with a PADOH2000 proportion of 41% wt., resp. 21% wt. The ratio of diols achieved in the obtained polymers corresponds approximately to the charged proportions.

Polymer Blends

Here, polymer blends are described which exhibit a thermally induced shape-memory effect. In this respect, the above described multiblock copolymers (PDA and PCA polymers) are mixed together in different proportions by weight. The crystallisable segment PPDO contained in the PDA polymers serves as the phase forming the hard segment and the crystallisable PCL blocks (Mₙ 2000·g·mol⁻¹) contained in the PCA polymers act as the phase forming the switching segment. The third amorphous PADOH segment contained in both polymers contributes to the entropy elasticity of the polymer blends. In contrast to the phase-separated multiblock copolymers described as shape-memory polymers, the two segments forming phases in the polymer blends are not linked together covalently, because they belong to different multiblock copolymers. A physical linkage can take place via the third phase, the amorphous PADOH phase.

Two methods for the production of the polymer blends are presented. On one hand the coprecipitation from solution and on the other hand coextrusion is involved.

Production of Binary Polymer Blends from Solution

First, the characteristics of the polymer blends are presented which are produced from a solution of the polymers PDA and PCA from the macro charges. Here, first the production and determination of the composition are discussed, then the thermal and mechanical characteristics and finally the shape-memory characteristics.

Production of Binary Polymer Blends from Solution and Determination of the Composition

For the production of polymer blends from solution there are three PDA polymers and two PCA polymers available with PADOH1000 as the amorphous soft segment, of which in each case two are processed together to form binary polymer blends. In this way six different blend series are accessible, which are listed in Tab. 0.7.

TABLE 0.7
Overview of the possible binary polymer blends: The individual
blend series are designated according to the multiblock copolymers
used, with PBS: “Polymer blend from solution”.

| | PCA(47, 2, 1) | PCA(68, 2, 1) |
|---|---|---|
| PDA(42, 1) | PBS42/47 | PBS42/68 |
| PDA(50, 1) | PBS50/47 | PBS50/68 |
| PDA(64, 1) | PBS64/47 | PBS64/68 |

The weight ratios of the polymer blends vary from 10:1 through 6:1, 4:1, 2:1, 1:1, 1:2 up to 1:4 of charged PDA polymer:charged PCA polymer. The composition of the binary polymer blends thus produced is determined by means of ¹H-NMR spectroscopy and compared with the corresponding charge. The composition is determined to be able to eliminate any possible losses of a polymer during the solution stage and the following precipitation stage.

In . . . a comparison of the appropriate compositions of the binary polymer blends from the solution is shown. The individual diagrams of the blend series are subdivided according to the polymer which the macro-diol PPDO contains as partially crystalline segment: Diagram A illustrates the polymer blends, which contain PDA(42) as a component, diagram B illustrates the polymer blends, which contain PDA(50) and diagram C illustrates the polymer blends, which contain PDA(64). Because each PDA component has been mixed with two PCA polymers, four mixing lines are entered in each diagram, whereby two lines of the composition correspond to the charged ingredients and two lines correspond to the composition found by ¹H-NMR spectroscopy.

Shape-memory Characteristics of the Polymer Blends from Solution

In this chapter the shape-memory characteristics of the produced polymer blends from solution are examined. With this system the permanent form is determined by the crystallites of the PPDO segments, which act as physical linkage points. The PCL segments, which facilitate fixing of the temporary shape through crystallisation of the segments, act as the phase forming the switching segment. The difference to the already described polyetheresterurethanes with shape-memory effect is firstly that these two phase-forming segments in the polymer blends are not linked together covalently and secondly in the presence of a third component, the amorphous PADOH. This contributes to the entropy elasticity of the polymer blends. In FIG. 3 the shape-memory effect in the polymer blends is shown schematically. Here, extension of the material above Tₜᵣₐₛ is possible, because the PCL segments are present amorphously and are mobile. During extension they are orientated and when cooled below Tₜᵣₐₙₛ these segments crystallise and the temporary shape is fixed. When the temperature is again increased, the crystallites of the PCL segments are again melted and the chains assume a tangled configuration. The samples return to their permanent shape (see FIG. 3).

The shape-memory characteristics of polymer blends are examined using cyclical thermo-mechanical experiments. Here, in particular the effect of the composition of the polymer blends on the shape-memory characteristics is shown.

Strain-controlled Thermo-mechanical Test Method

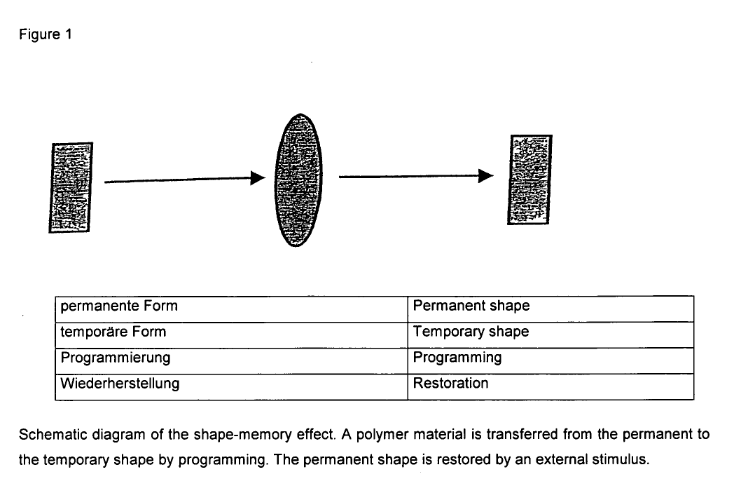

The examination of the shape-memory characteristics occurs through strain-controlled cyclical thermo-mechanical experiments. Here, the sample is stretched at a temperature above the switching segment transition temperature (Tₕ) to a specified maximum strain (εₘ) and held there for a certain time (tₕₐ). Then at constant strain, the material is cooled to a temperature below the switching segment transition temperature (T_{I}) at a cooling rate of β_{c}. This is maintained for a period (t_{I}) to fix the stretched state. Then the sample is released and the clamps of the materials testing machine are returned to the initial position. By heating the sample to Tₕ and maintaining it over a period t_{hb}, the permanent shape of the sample is restored; this concludes a cycle and it can be started again from the beginning. In FIG. 1 the typical trace for a strain-controlled, cyclical, thermo-mechanical tensile strain experiment is shown schematically.

Important quantities for the quantification of the shape-memory characteristics can be found from these cycles. Thus, the proportion of the maximum strain εᵤ fixed by the cooling process represents the measure of fixing in the cycle N. The strain fixity rate R_{f} can be determined from the ratio of the strain εᵤ of the strained, fixed sample and the real maximum strain ε_{I}.

$${R}_{f} ( N ) = \frac{{ɛ}_{u} ( N )}{{ɛ}_{l} ( N )} \cdot 100$$

The strain recovery rate Rᵣ of the cycle N is calculated from the strain ε_{I} and εₚ in the cycle N and the strain εₚ of the sample in the following cycle. Thus, for the calculation of Rᵣ(1), it follows that εₚ(N−1) is set equal to zero.

$${R}_{f} ( N ) = \frac{{ɛ}_{l} - {ɛ}_{p} ( N )}{{ɛ}_{l} - {ɛ}_{p} ( N - 1 )} \cdot 100$$

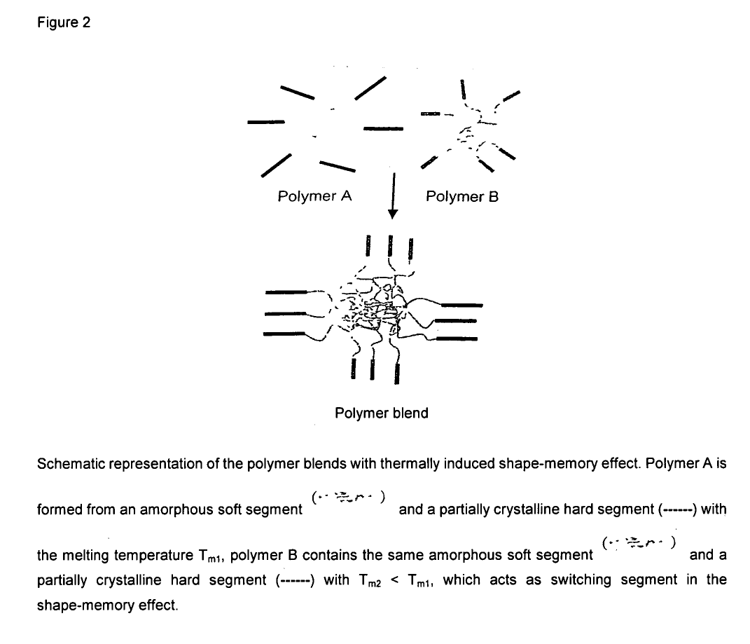

In FIG. 2 the measurement programme of the strain-controlled cycle is shown schematically. The dotted lines indicate a change of temperature from Tₕ to T_{I}. The vertical line (- - - ) describes the end of the first cycle. The next cycle then follows.

The standard parameters for the executed strain-controlled cycle can be taken from Chap. The holding times at T>Tₜᵣₐₙₛ and T<Tₜᵣₐₙₛ are 15 min. Five cycles are in each case measured. Further observations which are accessible from the strain-controlled cycle, are the relaxation behaviour of the sample and the change of stress on fixing the material.

Influence of the Composition

The examination of the shape-memory characteristics in dependence of the composition of the binary polymer blend from solution is examined on the materials which permit a strain of 100% at T>Tₜᵣₐₙₛ. If the mechanical characteristics are observed at 50° C., then the polymer blends, which contain PDA(64), cannot be examined, because their extensibility is not sufficiently high. FIG. 3 shows the typical trace of a standard experiment with an example of the polymer blend PDA(50)/PCA(47)[22/28]. The cycles N=1 and the following cycles N=2 to 5 are shown.

The real strain ε_{I} achieved is somewhat above εₘ for all cycles. It is noticeable that the strain recovery rate in the first cycle only reaches about 64%. This can be explained by yielding of the amorphous segments or by plastic deformation of the hard segment. The curves of the following cycles reach values for Rᵣ of more than 90%. This shows that a high strain recovery rate is only possible when the material has already been stretched once. Furthermore, a change in the stress can be observed during T>Tₜᵣₐₙₛ at constant strain and in the following cooling process. First, this reduces before it increases again. This relationship is illustrated in FIG. 4 in dependence of the time. Additionally, the trace of the temperature in dependence of time is shown.

The fall in the stress for a constant strain at T>Tₜᵣₐₙₛ can be attributed to a relaxation of the stress. The stress increases again on cooling to T<Tₜᵣₐₙₛ. This is attributed to the crystallisation of the phase forming the switching segment.

In Tab. 8 the experimentally obtained results from the strain-controlled, thermo-mechanical cycles can be seen. Here, the values R_{f}(1-5) indicate the mean of all cycles (N=1-5) and Rᵣ(2-4) indicates the mean of the cycles N=2 to N=4. All cycles are executed with a maximum strain εₘ of 100%.

TABLE 8
Shape-memory characteristics of the binary polymer blends from
solution in strain-controlled, cyclical, thermo-mechanical tensile
strain experiments (cf. Chap.). R_{f}(1-5) is the average strain
fixity rate from the cycles 1 to 5, Rᵣ(1), resp. Rᵣ(2) is the strain
recovery rate in the 1^{st} and 2^{nd} cycles and Rᵣ(2-4) is the
averaged strain recovery rate from the cycles 2 to 4.

| | εₘ | R_{f}(1-5) | Rᵣ(1) | Rᵣ(2) | Rᵣ(2-4) |
|---|---|---|---|---|---|
| Polymer blend | % | % | % | % | % |
| PDA(42)/ | 100 | 81.9 ± 0.8 | 80.3 | 97.1 | 97.3 ± 0.2 |
| PCA(47)[19/24] | | | | | |
| PDA(42)/ | 100 | 68.1 ± 0.3 | 73.9 | 96.3 | 98.1 ± 1.6 |
| PCA(47)[26/16] | | | | | |
| PDA(42)/ | 100 | 66.9 ± 1.0 | 84.7 | 96.8 | 98.9 ± 2.0 |
| PCA(47)[28/14] | | | | | |
| PDA(42)/ | 100 | 93.7 ± 0.5 | 76.6 | 94.5 | 97.4 ± 3.9 |
| PCA(68)[13/48] | | | | | |
| PDA(42)/ | 100 | 92.2 ± 0.3 | 73.3 | 96.6 | 98.6 ± 3.6 |
| PCA(68)[18/37] | | | | | |
| PDA(42)/ | 100 | 84.5 ± 0.3 | 72.8 | 97.2 | 98.2 ± 0.9 |
| PCA(68)[27/25] | | | | | |
| PDA(42)/ | 100 | 72.8 ± 0.3 | 76.8 | 95.9 | 97.2 ± 1.6 |
| PCA(68)[28/16] | | | | | |
| PDA(50)/ | 100 | 89.9 ± 1.6 | 62.1 | 87.7 | 90.6 ± 2.8 |
| PCA(47)[20/31] | | | | | |
| PDA(50)/ | 100 | 85.4 ± 2.1 | 63.8 | 95.1 | 95.1 ± 3.0 |
| PCA(47)[22/28] | | | | | |
| PDA(50)/ | 100 | 80.9 ± 0.3 | 55.0 | 91.0 | 94.6 ± 3.2 |
| PCA(47)[29/20] | | | | | |
| PDA(50)/ | 100 | 77.8 ± 2.9 | 63.8 | 92.0 | 95.1 ± 3.0 |
| PCA(47)[43/11] | | | | | |
| PDA(50)/ | 100 | 96.3 ± 0.8 | 58.6 | 95.7 | 94.6 ± 3.3 |
| PCA(68)[18/45] | | | | | |
| PDA(50)/ | 100 | 90.8 ± 0.6 | 55.3 | 94.4 | 94.0 ± 1.5 |
| PCA(68)[28/32] | | | | | |
| PDA(50)/ | 100 | 86.4 ± 1.1 | 57.1 | 91.8 | 96.5 ± 5.4 |
| PCA(68)[35/23] | | | | | |
| PDA(50)/ | 100 | 79.7 ± 2.0 | 66.0 | 104.5 | 101.9 ± 12.1 |
| PCA(68)[40/15] | | | | | |

The strain fixity rate of the samples increases with increasing proportion of the phase forming the switching segment and lies between 67% and 97%.

The increase of R_{f} with increasing switching segment content is due to the fact that during the cooling of the sample, the formation of the crystallites for fixing the temporary shape can take place to an increasing extent. With a higher proportion of blocks determining the switching segment a higher crystallinity is to be expected, so that a stronger physical linkage can occur and the temporary shape is fixed better.

For the first cycle, Rᵣ lies between 55% and 85% and in the second cycle assumes values of over 88%. The increase of Rᵣ after the first cycle is probably caused by a plastic deformation of the segments. Relaxation processes occur in which physical linkage points are released and crystallites of the phase forming the hard segment orientate in the direction of the acting force. It is only after one to several times of stretching that the samples enter equilibrium and the values for Rᵣ(2-4) approximate to a constant value of over 90%.

It is to be expected that Rᵣ increases with increasing PPDO content, because the permanent shape of the material is formed by the physical linkage points of the hard segment. Within the scope of the measurement accuracy almost no effect of the PPDO content on Rᵣ can be detected. Thus, the values for Rᵣ of the polymer blend PBS42/68 lie at about 98%, whereas a slight increase of Rᵣ can be observed for the other blend series.

For the commercial production of polymer blends the processing of the multiblock copolymers to form polymer blends by extrusion can be used. Therefore, in this section the characteristics of the binary polymer blends, which are produced by extrusion, are presented. First, the production and composition are explained, then the thermal characteristics are presented and following the mechanical characteristics, the shape-memory characteristics are examined.

Production of Binary Polymer Blends by Means of Extrusion and Determination of the Composition

In order to be able to process polymers by extrusion to form blends first the flakes of the pure multiblock copolymers (PDA and PCA) are extruded and the billet obtained is reduced to granulate. The granulates of the multiblock copolymers can be charged in the selected ratios and then extruded to polymer blends. The obtained billet of polymer blend is reduced again to granulate to ensure a thoroughly homogeneous blend and extruded a second time.

To check the even distribution of the individual components the composition in the resulting billet is examined in dependence of the dwell time in the extruder during the second extrusion. To do this, an example of a polymer blend is selected and the billet subdivided into sections. The composition of the sections is examined by means of ¹H-NMR spectroscopy. The extruded billet of a polymer blend PDA(42)/PCA(68)[23/40] is subdivided into uniform sections 70 cm in length and each part (T0-T9) is examined by ¹H-NMR spectroscopy (FIG. 5).

At the beginning of the second extrusion the proportions of PPDO and PCL vary. The proportion of PCL is initially high (45% wt.) and reduces to 39% wt. The proportion of PPDO increases from 21% wt. to 25% wt. The proportion of PADOH does not change from the beginning and after the subsection T4 the proportions of PPDO and PCL also assume constant values. For more extensive thermal and mechanical characterisation of the polymer blends, subsections from the centre of the extruded billet were therefore selected.

The results of the binary polymer blends, which were obtained from solution, act as the basic principle for the selection of the compositions of the possible polymer blends. From the large number of possible polymer blends, those were selected which allow a quantification of the shape-memory characteristics. In addition, three blends were produced from the polymer PDA(64) in combination with PCA(68). The combinations produced are listed in Tab. 9.

TABLE 9
Overview of the extruded binary polymer blends. The individual mixing
systems are designated according to the multiblock copolymers used;
with PBE: “Polymer blend by means of extrusion”.

| | PCA(47, 2, 1) | PCA(68, 2, 1) |
|---|---|---|
| PDA(42, 1) | PBE42/47 | PBE42/68 |
| PDA(50, 1) | PBE50/47 | PBE50/68 |
| PDA(64, 1) | — | PBE64/68 |

The charged ratios of the polymer granulates vary from 4:1 through 2:1, 1:1 and 1:2 of charged PDA polymer: charged PCA polymer.

Shape-memory Characteristics of the Extruded Polymer Blends

In this section the shape-memory characteristics of the extruded polymer blends are examined. Here firstly, the results of the strain-controlled standard cycles already described are discussed. Then, a further cyclical, thermo-mechanical experiment is presented, which enables the transition temperature of the shape-memory effect to be determined. The mechanism of the shape-memory effect in this polymer system corresponds to the mechanism explained in Chap.

Influence of the Composition of the Extruded Polymer Blends on the Shape-memory Characteristics

The strain-controlled standard cycles are carried out with the parameters given above. FIG. illustrates the typical trace of a strain-controlled, cyclical, thermo-mechanical experiment for the extruded polymer blend PDA(50)/PCA(68)[30/27].

The strain recovery rate Rᵣ of the first cycle is about 60%. It is only afterwards that Rᵣ has a value of 90%. Analogous to the experiment given in Chap., the sample is only in equilibrium ,after the first stretching; this is caused due to a plastic deformation of the hard segment. The physical linkage points are released by the relaxation processes and the crystallites of the phase forming the hard segment orientate in the direction of the force acting on them. The strain fixity rate R_{f} after the first cycle is about 90%. In Tab. 10 the experimentally obtained results from the strain-controlled, cyclical, thermo-mechanical cycles of the extruded polymer blends can be seen. R_{f}(1-5) indicates the mean of all cycles (N=1-5) and Rᵣ(2-4) indicates the mean of the cycles N=2 to N=4. All cycles are executed with a maximum strain Em of 100%.

TABLE 10
Shape-memory characteristics of the binary, extruded polymer blends
in the strain-controlled, thermo-mechanical standard experiment
(cf. Chap.). R_{f}(1-5) is the average strain fixity rate from the
cycles 1 to 5, Rᵣ(1), resp. Rᵣ(2) is the strain recovery rate in the
1^{st} resp. 2^{nd} cycle, Rᵣ(2-4) is the averaged strain recovery rate
from the cycles N = 2 to N = 4.

| | εₘ | R_{f}(1-5) | Rᵣ(1) | Rᵣ(2) | Rᵣ(2-4) |
|---|---|---|---|---|---|
| Polymer blend | % | % | % | % | % |
| PDA(42)/PCA(47)[17/27] | 100 | 86.6 ± 0.5 | 63.8 | 91.7 | 95.2 ± 2.8 |
| PDA(42)/PCA(47)[24/18] | 100 | 75.8 ± 3.1 | 67.7 | 93.9 | 95.1 ± 1.3 |
| PDA(42)/PCA(47)[26/16] | 100 | 73.2 ± 2.7 | 70.1 | 92.8 | 95.2 ± 2.1 |
| PDA(42)/PCA(68)[13/46] | 100 | 98.4 ± 0.4 | 59.5 | 82.2 | 84.0 ± 3.1 |
| PDA(42)/PCA(68)[17/42] | 100 | 95.7 ± 0.3 | 58.9 | 90.1 | 92.4 ± 2.0 |
| PDA(42)/PCA(68)[23/29] | 100 | 89.8 ± 1.2 | 68.2 | 92.2 | 96.1 ± 3.5 |
| PDA(42)/PCA(68)[29/19] | 100 | 87.4 ± 0.3 | 63.9 | 94.5 | 96.6 ± 3.0 |
| PDA(50)/PCA(47)[28/23] | 100 | 86.3 ± 5.1 | 62.5 | 96.2 | 96.6 ± 0.9 |
| PDA(50)/PCA(47)[29/21] | 100 | 79.6 ± 0.6 | 71.5 | 97.3 | 98.7 ± 3.6 |
| PDA(50)/PCA(47)[37/14] | 100 | 73.8 ± 5.4 | 67.7 | 93.9 | 95.8 ± 3.5 |
| PDA(50)/PCA(68)[10/49] | 100 | 99.1 ± 1.2 | 58.6 | 83.4 | 88.9 ± 4.8 |
| PDA(50)/PCA(68)[23/40] | 100 | 92.9 ± 0.1 | 61.6 | 93.6 | 95.0 ± 1.7 |
| PDA(50)/PCA(68)[30/27] | 100 | 89.7 ± 1.8 | 60.0 | 94.2 | 96.0 ± 2.3 |
| PDA(50)/PCA(68)[37/17] | 100 | 78.4 ± 2.8 | 64.4 | 94.1 | 97.6 ± 2.5 |

Rᵣ of the first cycle Rᵣ(1) lies for all polymer blends below the strain recovery rate of the second cycle Rᵣ(2). Rᵣ for the first cycle lies between 59% and 70% and that for the second cycle between 82% and 95%. The values of Rᵣ increase within a blend series with increasing hard segment proportion.

The slight increase of Rᵣ within the individual blend series confirms that the hard segment determines the permanent shape of the material. The higher the proportion of hard segment is, the higher is the proportion of physical linkage points and thus the restoration of the material.

The strain fixity rate of the materials should depend on the proportion of switching segment; the higher this proportion is, the better possible is the fixing of the temporary shape.

As expected, R_{f} increases with increasing proportion of the blocks forming the switching segment from 73% to 99%. The fixing of the temporary shape occurs due to the crystallisation of the switching segment during the cooling stage. The higher is the content of switching segment, the higher is the expected crystallinity, which causes a physical linkage of the material. Thus, the fixing of the temporary shape is improved.

1. Polymer blend with shape-memory characteristic comprising two different block copolymers each containing at least one hard segment and at least one soft segment, wherein the two different block copolymers comprise the same soft segment and only differ with regard to the hard segment.

2. Polymer blend according to claim 1, wherein the hard and soft segments are selected from polyester segments and polyetherester segments.

3. Polymer blend according to claim 1, wherein the hard and soft segments are linked together by urethane bindings.

4. Polymer blend according to claim 1, wherein the hard and soft segments are not aromatic.

5. Polymer blend according to claim 1, wherein the soft segment is selected from the group consisting of copolyepsilon caprolactone glycolide and polyalkylene adipinate.

6. Polymer blend according to claim 1, wherein the hard segment is selected from poly-p-dioxanone and polyepsilon caprolactone.

7. Polymer blend according to claim 1, wherein the two block copolymers themselves do not exhibit any shape-memory characteristics.

8. Method for producing a polymer blend according to claim 1, wherein the two block copolymers are either mixed together in solution, whereupon the blend is obtained either by evaporation of the solvent or by precipitation, or wherein the two block copolymers are mixed in the melt, preferably by using an extruder.

9. Block copolymer, comprising at least one hard segment and at least one soft segment, wherein the hard segment is selected from poly-p-dioxanone and polyepsilon caprolactone and wherein the soft segment is selected from copolyepsilon caprolactone glycolide and polyalkylene adipinate.

10. Method for producing a block copolymer according to claim 9, comprising the provision of precursor substances for the hard segment, respectively for the soft segment, preferably in the form of diols, and reaction of the precursor substances with the formation of a polymer, preferably with the use of a diisocyanate for linking of the individual segments by urethane bindings.

11. (canceled)

12. Polymer blend with shape-memory characteristic, comprising two different block copolymers, each containing at least one hard segment and at least one soft segment, wherein the segments of the respective block copolymers are linked together by urethane segments.
